(19) United States
(12) Patent Application Publication
(10) Pub. No.: US 2007/0202891 A1
(43) Pub. Date: Aug. 30, 2007

(54) Methods for Reducing Paging Load in Generic Access Networks

(76) Inventors: John Walter Diachina, Garner, NC (US); Jari Tapio Vikberg, Jarna (SE)

Correspondence Address: ERICSSON INC., 6300 LEGACY DRIVE, M/S EVR 1-C-11, PLANO, TX, 75024, US

(21) Appl. No.: 11/276,415

(22) Filed: Feb. 28, 2006

(51) Int. Cl. H04Q 7/20

(52) U.S. Cl. 455/458

(57) ABSTRACT

Methods for reducing paging load when a Mobile Station (MS) switches between a cell providing access according to a first radio access technology (RAT) and a cell providing access according to General Access Network (GAN) radio access technology, wherein different radio resource (RR) entities in the MS are associated with the first RAT and the GAN radio access technology, a combined radio access network (RAN) controller manages cells associated with the first RAT and the GAN, and the combined RAN controller is unable to independently determine when the MS switches service from the first RAT to the GAN, and vice versa. When an MS has successfully acquired service from a wireless access point associated with the GAN (i.e., it has successfully performed a GAN registration procedure towards a GAN controller (GANC) using that wireless access point), wherein the wireless access point is associated with a cell in the same geographical service area as a cell associated with the first RAT through which the MS was previously receiving service, it sends a message to the combined RAN controller indicating that the GAN RR entity has become the serving RR entity in the MS, whereby the combined RAN controller can forward all future paging messages for the MS only through the access point associated with the GAN.

### TECHNICAL FIELD OF THE INVENTION

The invention is related, in general, to the field of wireless telecommunications and, in particular, to the field of Generic Access Networks (GAN).

### BACKGROUND OF THE INVENTION

In addition to the advancements made in cellular telecommunications systems and devices in recent years, significant improvements have been made to other communications technologies, such as wireless computer networks and Voice over Internet Protocol (VoIP). Unlike conventional cellular telecommunications systems and devices which utilize licensed radio spectrum, wireless computer network devices typically employ unlicensed radio spectrum, such as devices conforming to the IEEE 802.11 (WiFi) standards. These unlicensed radio spectrum devices allow anyone to easily add wireless access capabilities to their homes and businesses.

Another relatively recent development in communications is the use of Voice over Internet Protocol (VoIP) services. As more and more people have access to broadband Internet access, the use of VoIP services has accelerated due to the low cost of calls—some such services even offering free calls. To access VoIP services, a user typically needs to use a computer or special telephone adapter. Some vendors, however, are beginning to introduce cellular telephones equipped with WiFi or Bluetooth® interfaces that allow access to a VoIP network.

A 3GPP Technical Specification Group (TSG) recently introduced the Generic Access Networks (GAN) specification, which provides for another radio access technology (RAT) through which a mobile station (MS) may acquire voice and data service. A GAN network employs unlicensed radio spectrum, unlike other radio access technologies such as GSM/EDGE Radio Access Networks (GERAN) and Universal Terrestrial Radio Access Networks (UTRAN) in Universal Mobile Telecommunications Systems (UMTS). GAN is based on the use of IP access networks between the MS and a node known as a GAN Controller (GANC). The GANC connects to a Core Network (CN) using the same interfaces and protocols as a Base Station Subsystem/Base Station Controller (BSS/BSC) in a Global System for Communications (GSM) network (i.e., the A- and Gb-interfaces and associated protocols). The IP access network between the MS and the GANC involves the use of unlicensed radio Access Points (AP) based on, for example, WiFi or Bluetooth®, to provide IP connectivity to the MS. IP connectivity between the AP and the GANC is provided using, for example, Digital Subscriber Line (xDSL) or cable television (CATV) broadband networks.

During the course of normal MS mobility, it may enter the service area offered by a different RAT while the service coverage provided by the RAT it is currently using may either remain fully available or may be degrading. It is obvious to a MS when it switches to (i.e., acquires service on) a cell associated with a RAT that is different from the RAT where it last had service. Therefore, a MS always knows which radio resource (RR) entity to use in its serving cell as the RR entity in use directly corresponds to the RAT on which the MS currently has service. In light of legacy system operation, it is also obvious to the core network when a MS toggles between cells providing UTRAN service and GSM/GPRS service because system information broadcast in those cells will normally ensure that the MS provides the core network (e.g., Mobile Service Center (MSC) or Supporting GPRS Support Node (SGSN)) with a notification of its presence in the new cell. However, it will not necessarily be obvious to the network if a MS toggles between cells providing GSM/GPRS or UTRAN service and GAN service. If the core network is unaware that a MS has toggled between such cells, it will be necessary to send paging messages through both the GSM/GPRS or UTRAN cell and the GAN cell, which will increase both the core network processing load and the air interface signaling load. Accordingly, there is a need in the art for methods to reduce paging load for networks allowing MS access through IP access networks according to the GAN specification.

### SUMMARY OF THE INVENTION

To overcome the deficiencies of the prior art, the present invention discloses methods for reducing paging load when a Mobile Station (MS) toggles between a cell providing access according to a first radio access technology (RAT) and a cell providing access according to General Access Network (GAN) radio access technology, wherein different radio resource (RR) entities in the MS are associated with the first RAT and the GAN radio access technology, and wherein a combined radio access network (RAN) controller manages cells associated with the first RAT and the GAN, the combined RAN controller is unable to independently determine when the MS toggles service to and from the first RAT to the GAN. When a MS has successfully acquired service from a wireless access point associated with the GAN (i.e., it has successfully performed a GAN registration procedure towards a GAN controller (GANC), using that wireless access point, and a registration acknowledgement message sent from the GANC includes Location Area Identity and Routing Area Identity information), wherein the wireless access point is associated with a cell in the same geographical service area as a cell associated with the first RAT through which the MS was previously receiving service, it sends a notification message to the combined RAN controller indicating that the GAN RR entity has become the serving RR entity in the MS, whereby the combined RAN controller can forward all future paging messages for the MS only through the access point associated with the GAN. In a preferred embodiment, the combined RAN controller then sends a notification acknowledgement message to the MS. When the MS is ready to switch service from a wireless access point associated with the GAN back to the first RAT, it sends to the combined RAN controller a notification message indicating that the GAN RR entity is no longer the serving RR entity in the MS, whereby the combined RAN controller can forward all future paging messages for the MS only through the first RAT.

The invention has particular advantages in embodiments in which the first radio access technology utilizes licensed spectrum and the GAN radio access technology utilizes unlicensed spectrum. In such embodiments, for example, the first radio access technology can be a GSM/Edge Radio Access Network (GERAN) or a Universal Terrestrial Radio Access Network (UTRAN), and the GAN radio access technology can conform to IEEE 802.11 or Bluetooth®. In exemplary embodiments, the notification messages used to indicate whether or not the GAN RR entity is the serving RR entity are control plane messages corresponding to Generic Access-Circuit Switched Resource (GA-CSR) or Generic Access-Packet Switched Resource (GA-PSR) protocol entities defined for the GAN radio access technology. The notification messages can also be realized using registration plane messages corresponding to Generic Access-Resource Control (GA-RC).

The foregoing has outlined, rather broadly, the principles of the present invention so that those skilled in the art may better understand the detailed description of the exemplary embodiments that follow. Those skilled in the art should appreciate that they can readily use the disclosed conception and exemplary embodiments as a basis for designing or modifying other structures and methods for carrying out the same purposes of the present invention. Those skilled in the art should also realize that such equivalent constructions do not depart from the spirit and scope of the invention in its broadest form, as defined by the claims provided hereinafter.

### BRIEF DESCRIPTION OF THE FIGURES

To illustrate the features and functions of the invention, reference is now made to the following detailed description taken in conjunction with the accompanying drawings, in which:

FIG. 1 illustrates a wireless network architecture including a Generic Access Network (GAN);

FIG. 2 illustrates a Mobile Station (MS) architecture having multiple Radio Resource (RR) protocol entities;

FIG. 3 illustrates an first exemplary signaling diagram according to the prior art;

FIG. 4 illustrates a second exemplary signaling diagram according to the prior art;

FIG. 5 illustrates a first exemplary signaling diagram in accordance with the principles of the invention; and,

FIG. 6 illustrates a second exemplary signaling diagram in accordance with the principles of the invention.

### DETAILED DESCRIPTION

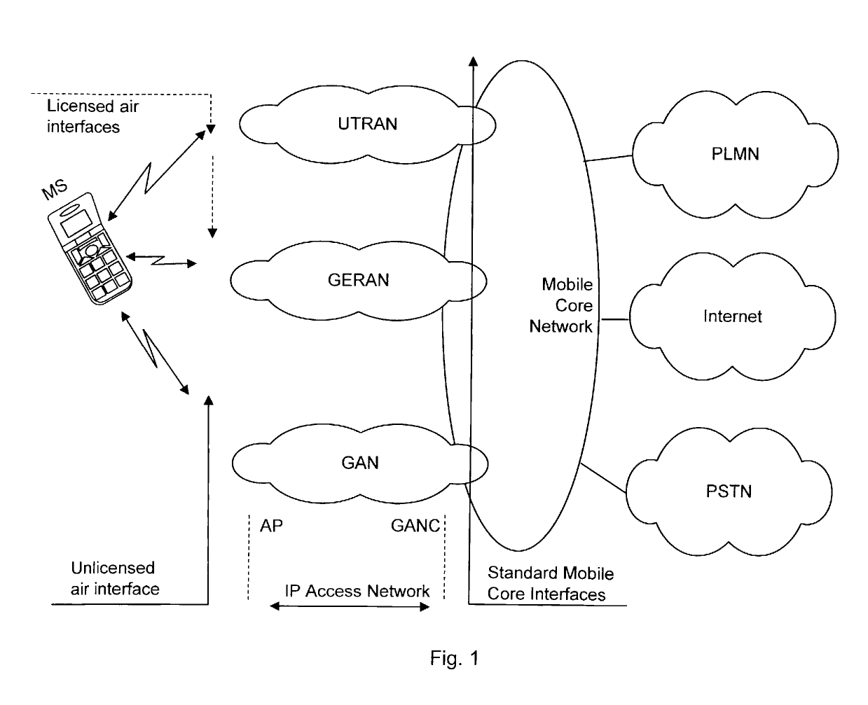

FIG. 1 illustrates a wireless network architecture including a Generic Access Network (GAN). Standard mobile core interfaces are used between the mobile core network (CN) and GSM/Edge Radio Access Network (GERAN), Universal Terrestrial Radio Access Network (UTRAN), and GAN. An MS communicates with the GERAN and UTRAN radio access technologies (RATs) using licensed radio spectrum, and the GAN using unlicensed radio spectrum, such as WiFi or Bluetooth®. The GAN comprises an access point (AP; not shown) and a GAN controller (GANC; not shown) coupled, for example, through a Digital Subscriber Line (xDSL) or Cable Television (CATV) broadband network. The mobile core network is further coupled to a Public Land Mobile Network (PLMN), the Internet and the Public Switched Telephone Network (PSTN).

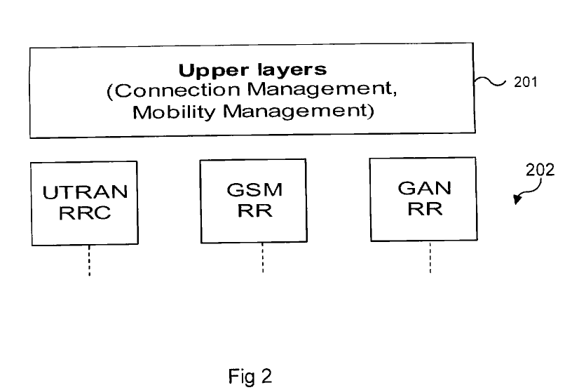

As a MS moves throughout cells having access to the UTRAN, GERAN and GAN radio access technologies, it can switch between them. As illustrated in FIG. 2, the MS architecture is characterized by upper protocol layers 201 that handle connection and mobility management, with lower layer radio resource (RR) protocol entities 202 which control paging and allocation of radio resources to be used for MS terminated calls and other transactions (e.g., MS terminated SMS, Location Services); the RR protocol entities can also be used for MS originated transactions. The invention addresses a problem associated with MS mobility between different RATs and the use of such RR protocol entities.

It is obvious to an MS when it switches to (i.e., acquires service on) a cell associated with a RAT that is different from the RAT where it last had service. As such, the MS always knows which RR protocol entity to use as the serving RR entity in its serving cell. In light of legacy system operation, it is also obvious to the network when a MS toggles between cells providing UTRAN or GSM/GPRS service, because system information broadcast in those cells will normally ensure that the MS provides the core network (i.e., Mobile Service Center (MSC) or Supporting GPRS Support Node (SGSN)) with a notification of its presence in the new cell and, therefore, the new serving RAT. It will not necessarily, however, be obvious to the network if the MS toggles between cells providing GSM/GPRS or UTRAN service and GAN service.

A Paging Area (PA) is a part of a mobile network where the network pages a MS when it needs to reach it, such as for mobile terminated calls. For Circuit Switched (CS) domains, a Location Area (LA) is the paging area and for PS domain, a Routing Area (RA) is used as the Paging area for an idle MS. An MS will inform the network when it moves between different Location Areas and different Routing Areas while in idle mode. A Location Area Identity (LAI) and a Routing Area Identity (RAI) are broadcast as part of the system information in each cell so a MS knows when it is switching to another LA/RA.

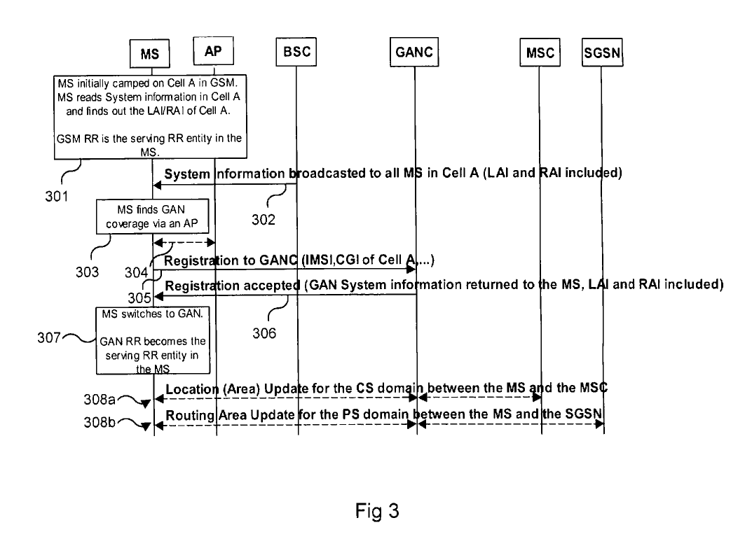

Turning now to FIG. 3, illustrated is an exemplary signaling diagram corresponding to a case in which a MS is initially camped on a GSM cell A (301) and the GSM/GPRS RR entity is the serving RR entity in the MS. As per legacy GSM/GPRS operation, the MS receives the LAI and RAI via broadcast information (302) in the GSM cell and performs Location and Routing Area Updates towards the core network (CN). While still camped in GSM Cell A, and using the GSM/GPRS RR entity, the MS detects a GAN-related radio access point (AP) that can provide IP-connectivity (303). The MS joins that AP (304) and initiates GAN Registration (305) towards a GAN controller (GANC) as specified in the GAN standard (see: 3GPP TS 43.318—Generic Access to the A/Gb Interface—Stage 2, and 3GPP TS 44.318—Generic Access to the A/Gb Interface—Stage 3, both incorporated herein by reference). If the GANC accepts the registration (306), it will indicate this to the MS and also return the GAN system information to the MS (including LAI and RAI associated with the GAN coverage/cell) and the MS is then able to switch to GAN mode. When the MS decides to switch over to GAN mode (307), the GAN RR becomes the serving RR protocol entity in the MS and passes the relevant part of the received GAN system information to the upper protocol layers. If the received LAI and RAI are different from the previous LAI/RAI received in the GSM cell (or GPRS cell) (which is the normal configuration in this case), the upper protocol layers trigger Location Area and Routing Area update procedures towards the network (308a, 308b).

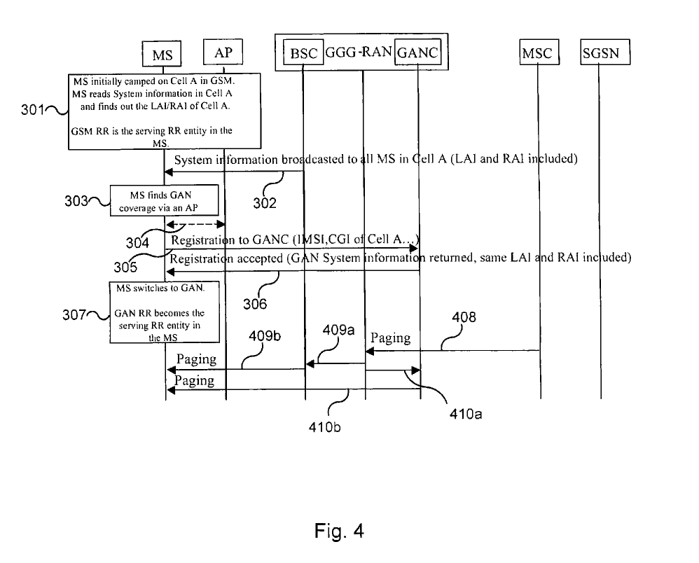

A problem can occur, however, if an MS switches between a cell providing GSM/GPRS service and a cell providing GAN service in the same geographical service area, where each cell is associated with the same Location Area Identity (LAI) and Routing Area Identity (RAI) and where a combined radio access network (RAN) is used to manage the GSM/GPRS cells and GAN cells; as used herein, such a combined radio access network is referred to as a GSM/GPRS/GAN-RAN, or GGG-RAN. In this case, the GGG-RAN is unaware when a MS switches from one RAT to another and, therefore, it will not know which RR entity is being used in the MS. This results in an increased GGG-RAN processing load and an increased air interface signaling load because, for each circuit switched (CS) page or packet switched (PS) page received from the core network (i.e., an MSC for CS pages and an SGSN for PS pages), the GGG-RAN will have no choice but to send out an air interface page in a least one GAN cell (using GAN RR) and in at least one GSM/GPRS cell (using GSM/GPRS RR), even though the MS will only be listening for a page using one of the RR entities. This problem is further shown in FIG. 4.

FIG. 4 illustrates a case in which the GSM cell and the GAN cell belong to the same LAI/RAI and the GGG-RAN will not know when the MS switches between these cells as no Location Area and Routing Area updates are performed. When a Paging message is received, for example, from the MSC (408), it needs to be sent out both to the GSM cells, via the BSC (409a, 409b), belonging to the indicated Location Area and to the GAN cell, via the GANC (410a, 410b), where the MS is registered (which is also part of the same Location Area). To reduce the paging load in this case, it is proposed to add two new GAN RR notifications to the existing GAN standard that the MS can send to the GGG-RAN upon entering GAN mode (i.e., enabling the GAN RR entity) or upon leaving GAN mode (i.e., disabling the GAN RR entity). The new GAN RR notifications can be realized by modifying control planes messages belonging to the existing Generic Access-Circuit Switched Resource (GA-CSR) and Generic Access-Packet Switched Resource (GA-PSR) protocol entities defined for GAN mode operation. Another option is to modify existing GA-CSR and GA-PSR protocol messages to realize the new GAN RR notifications. For example, the GA-RC KEEP ALIVE message would be suitable because the MS sends this message frequently to the GANC; a new information element could be added to this message to indicate the state of the GAN RR entity (i.e., Serving or Not Serving).

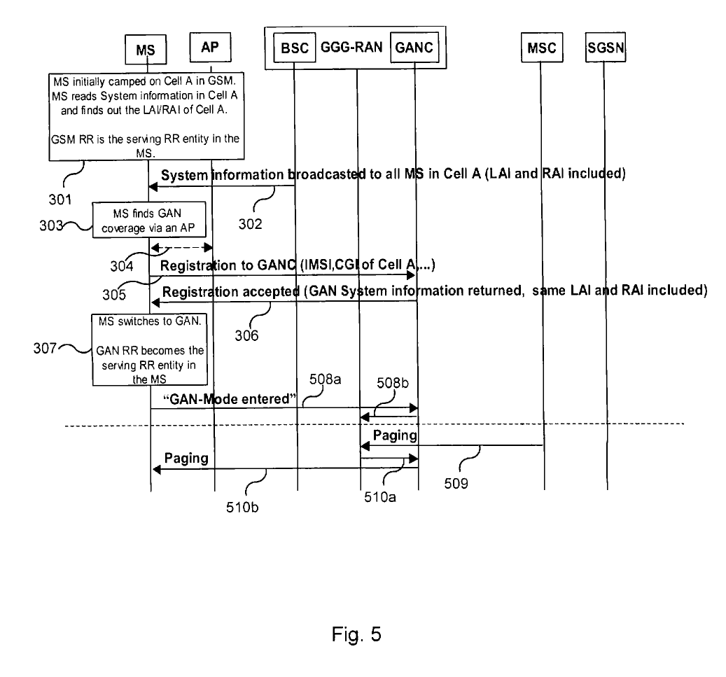

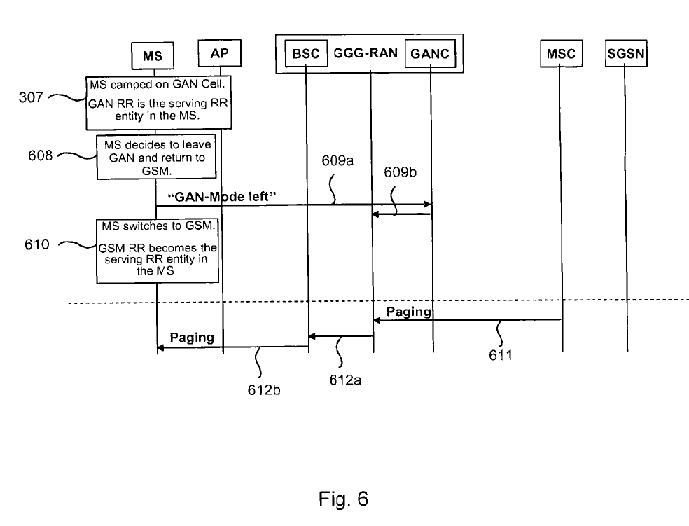

Turning now to FIG. 5, illustrated is an exemplary case in which a MS enters GAN mode in accordance with the principles of the invention. The MS sends a notification message (508a) to the GANC to indicate that GAN RR has become the serving RR entity in the MS; this indication is also provided to the GGG-RAN (508b). If the GGG-RAN receives paging messages (509) from the CN, it now knows that it is enough to forward the paging messages only to the GAN cell, via the GANC (510a, 510b). Similarly, FIG. 6 illustrates an exemplary case in which a MS first decides to terminate GAN mode (608) in accordance with the principles of the invention. The MS sends a message (609a) to the GANC to indicate that the GAN RR is no longer the serving RR entity in the MS; this indication is also provided to the GGG-RAN (609b). This could also be implicitly detected by the GGG-RAN, if it deregisters the MS for some reason (e.g., missing GA-RC KEEP ALIVE messages); however the time required for the GGG-RAN to make this implicit determination may require more time than the case where the MS explicitly sends a message providing an indication of a change in the serving RR entity. The MS then switches back to GSM mode (610). If the GGG-RAN receives paging messages (611) from the CN, it now knows that it doesn't need to forward the paging messages to the GAN cell anymore, but only to the GSM cells, via the BSC (612a, 612b). Thus, those skilled in the art will recognize that the invention decreases paging load in the macro network (GSM/GPRS network) when the MS is in GAN mode, as it is sufficient to page the MS only in the GAN cell. Furthermore, those skilled in the art will recognize that the logic in the GGG-RAN can be simplified because it will always know where to forward paging messages.

A similar problem can occur if a MS switches between a cell providing UTRAN service and a cell providing GAN service in the same geographical service area, where each cell is associated with the same LAI and RAI and is controlled by the same core network nodes (e.g. the UTRAN cell is controlled by RAN1 and MSC1/SGSN1 and the GAN cell is controlled by RAN2 and MSC1/SGSN1). In this case, the MSC1/SGSN1 will be unaware when a MS changes from one RAT to another and, therefore, will not know which RAN (i.e., RAN1 or RAN2) to contact when it needs to send a circuit-switched (CS) or packet-switched (PS) page to the MS. This results in increased MSC/SGSN and RAN processing load and increased air interface signaling load as the core network has no choice but to transmit a CS/PS page to both RAN1 and RAN2. This results in the page being sent out in at least one GAN cell (using GAN RR) and in at least one UTRAN cell (using UTRAN RR), even though the MS will only be listening for a page using one of the RR entities. To eliminate this additional MSC/SGSN and RAN processing load and air interface signaling load, core network mobility management (MM) messages can be sent by the MS upon entering GAN mode (i.e., enabling the GAN RR entity) or upon leaving GAN mode (i.e., disabling the GAN RR entity). The core network messages can be defined for any control plane protocol entity that operates between the MS and the MSC/SGSN.

Although the present invention has been described in detail, those skilled in the art will conceive of various changes, substitutions and alterations to the exemplary embodiments described herein without departing from the spirit and scope of the invention in its broadest form. The exemplary embodiments presented herein illustrate the principles of the invention and are not intended to be exhaustive or to limit the invention to the form disclosed; it is intended that the scope of the invention be defined by the claims appended hereto, and their equivalents.

We claim:

1. A method for reducing paging load when a Mobile Station (MS) switches between a cell providing access according to a first radio access technology (RAT) and a cell providing access according to General Access Network (GAN) radio access technology, wherein different radio resource (RR) entities in said MS are associated with said first RAT and said GAN, and wherein a combined radio access network (RAN) controller manages cells associated with said first RAT and said GAN, said combined RAN controller unable to independently determine when said MS toggles service to from said first RAT to said GAN, comprising the steps of:
acquiring service, by said MS, from a wireless access point associated with said GAN, wherein said wireless access point is associated with a cell in the same geographical service area as a cell associated with said first RAT through which said MS is currently receiving service; and,
sending, from said MS to said combined RAN controller, a message indicating that its GAN RR entity is to be the serving RR entity in the MS, whereby said combined RAN controller can forward all future paging messages for said MS only through said access point associated with said GAN.

2. The method recited in claim 1, wherein said first radio access technology utilizes licensed spectrum and said GAN radio access technology utilizes unlicensed spectrum.

3. The method recited in claim 2, wherein said first radio access technology comprises a GSM/Edge Radio Access Network (GERAN).

4. The method recited in claim 2, wherein said first radio access technology comprises a Universal Terrestrial Radio Access Network (UTRAN).

5. The method recited in claim 2, wherein said GAN radio access technology conforms to IEEE 802.11.

6. The method recited in claim 2, wherein said GAN radio access technology conforms to Bluetooth®.

7. The method recited in claim 1, wherein said message comprises a control plane message corresponding to a Generic Access-Circuit Switched Resource (GA-CSR) protocol entity defined for said GAN radio access technology.

8. The method recited in claim 1, wherein said message comprises a control plane message corresponding to a Generic Access-Packet Switched Resource (GA-PSR) protocol entity defined for said GAN radio access technology.

9. The method recited in claim 1, wherein said message comprises a registration plane message corresponding to a Generic Access-Resource Control (GA-RC) protocol entity defined for said GAN radio access technology.

10. The method recited in claim 1, further comprising the step of said combined RAN controller sending an acknowledgement message to said MS.

11. The method recited in claim 10, wherein said acknowledgement message comprises Location Area Identity and Routing Area Identity information.

12. A method for reducing paging load when a Mobile Station (MS) switches between a cell providing access according to General Access Network (GAN) radio access technology and a cell providing access according to a second radio access technology (RAT), wherein different radio resource (RR) entities in said MS are associated with said GAN and said second RAT, and wherein a combined radio access network (RAN) controller manages cells associated with said GAN and said second RAT, said combined RAN controller unable to independently determine when said MS toggles service from said GAN to said second RAT, comprising the steps of:
switching service, by said MS, from a wireless access point associated with said GAN to said second RAT, wherein said wireless access point is associated with a cell in the same geographical service area as a cell associated with said second RAT; and,
sending, from said MS to said combined RAN controller, a message indicating that the GAN RR entity is no longer the serving RR entity in the MS, whereby said combined RAN controller can forward all future paging messages for said MS only through said second RAT.

13. The method recited in claim 12, wherein said second radio access technology utilizes licensed spectrum and said GAN radio access technology utilizes unlicensed spectrum.

14. The method recited in claim 13, wherein said second radio access technology comprises a GSM/Edge Radio Access Network (GERAN).

15. The method recited in claim 13, wherein said second radio access technology comprises a Universal Terrestrial Radio Access Network (UTRAN).

16. The method recited in claim 13, wherein said GAN radio access technology conforms to IEEE 802.11.

17. The method recited in claim 13, wherein said GAN radio access technology conforms to Bluetooth®.

18. The method recited in claim 12, wherein said message comprises a control plane message corresponding to a Generic Access-Circuit Switched Resource (GA-CSR) protocol entity defined for said GAN radio access technology.

19. The method recited in claim 12, wherein said message comprises a control plane message corresponding to a Generic Access-Packet Switched Resource (GA-PSR) protocol entity defined for said GAN radio access technology.

20. The method recited in claim 12, wherein said message comprises a registration plane message corresponding to a Generic Access-Resource Control (GA-RC) protocol entity defined for said GAN radio access technology.

21. A method for reducing paging load in a combined radio access network (RAN) controller which manages cells associated with a first radio access technology (RAT) and cells providing access according to General Access Network (GAN) radio access technology, said combined RAN controller unable to independently determine when a mobile station (MS) switches between a cell providing access according to said first RAT and a cell providing access according to said GAN radio access technology, wherein different radio resource (RR) entities in said MS are associated with said first RAT and said GAN, comprising the steps of:
receiving at said combined RAN controller, from said MS, a message indicating that the MS's GAN RR entity is to be the serving RR entity in the MS, said message transmitted by said MS when it acquires service from a wireless access point associated with said GAN, wherein said wireless access point is associated with a cell in the same geographical service area as a cell associated with said first RAT through which said MS is receiving service;
sending, from said combined RAN controller to said MS, an acknowledgement message; and,
forwarding, from said combined RAN controller, all future paging messages for said MS only through said access point associated with said GAN.

22. The method recited in claim 21, wherein said first radio access technology utilizes licensed spectrum and said GAN radio access technology utilizes unlicensed spectrum.

23. The method recited in claim 22, wherein said first radio access technology comprises a GSM/Edge Radio Access Network (GERAN).

24. The method recited in claim 22, wherein said first radio access technology comprises a Universal Terrestrial Radio Access Network (UTRAN).

25. The method recited in claim 22, wherein said GAN radio access technology conforms to IEEE 802.11.

26. The method recited in claim 22, wherein said GAN radio access technology conforms to Bluetooth®.

27. The method recited in claim 21, wherein said message indicating that the MS's GAN RR entity is to be the serving RR entity in the MS comprises a control plane message corresponding to a Generic Access-Circuit Switched Resource (GA-CSR) protocol entity defined for said GAN radio access technology.

28. The method recited in claim 21, wherein said message indicating that the MS's GAN RR entity is to be the serving RR entity in the MS comprises a control plane message corresponding to a Generic Access-Packet Switched Resource (GA-PSR) protocol entity defined for said GAN radio access technology.

29. The method recited in claim 21, wherein said message comprises a registration plane message corresponding to a Generic Access-Resource Control (GA-RC) protocol entity defined for said GAN radio access technology.

30. The method recited in claim 21, wherein said acknowledgement message comprises Location Area Identity and Routing Area Identity information.

31. The method recited in claim 21, further comprising the steps of:
receiving, from said MS at said combined RAN controller, a message indicating that the GAN RR entity is no longer the serving RR entity in the MS, said MS transmitting said message when said MS switches service from said wireless access point associated with said GAN to said first RAT, wherein said wireless access point is associated with a cell in the same geographical service area as a cell associated with said first RAT; and,
forwarding, from said combined RAN controller to said MS, all future paging messages for said MS only through said first RAT.
